(19) United States
(12) Patent Application Publication
(10) Pub. No.: US 2007/0055700 A1
(43) Pub. Date: Mar. 8, 2007

(54) Method and apparatus for selecting and playing multimedia file playable in embedded device

(75) Inventors: Do-jun Yang, Yongin-si (KR); Zhang-hoon Oh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/505,922

(22) Filed: Aug. 18, 2006

(30) Foreign Application Priority Data
Aug. 24, 2005 (KR) 10-2005-0077902

(51) Int. Cl. G06F 17/00; G06F 17/30

(52) U.S. Cl. 707/104.1; 715/500.1; 707/1

(57) ABSTRACT

An embedded device includes a content organizer receiving a header containing information on a multimedia file and extracting information required for playing the multimedia file from the header, a database storing the extracted information for each multimedia file, and a decoding unit playing the multimedia file based on the information extracted by the content organizer.

### CROSS-REFERENCE TO RELATED APPLICATION

This application claims priority from Korean Patent Application No. 10-2005-0077902 filed on Aug. 24, 2005 in the Korean Intellectual Property Office, the disclosure of which is incorporated herein in its entirety by reference.

### BACKGROUND OF THE INVENTION

1. Field of the Invention

Methods and apparatuses consistent with the present invention relate to an embedded device, and more particularly methods and apparatuses consistent with the present invention relate to selecting and playing a multimedia file playable in an embedded device.

2. Description of the Prior Art

With the development of various kinds of multimedia content, apparatuses for playing such multimedia content have also become diversified. The apparatuses for playing multimedia content, such as desktop computers, laptop computers, MP3 players, PDAs, HPCs, mobile phones, and others, have been adapted and have different processing capabilities. Desktop computers and laptop computers have relatively high processing capabilities while MP3 players, PDAs and HPCs may have different processing capabilities depending on the characteristics of their embedded devices.

Specifically, if a playback of multimedia content is only one among a plurality of functions of an appliance, collision of the multimedia content playback function with other functions of the appliance must be avoided. For example, a communication function, which is an important function of the mobile phone, should not be interrupted by the multimedia content playback operation in the mobile phone, or a scheduling function to be processed in a PDA should not be stopped during the multimedia content playback operation in the PDA.

FIG. 1 is a view illustrating the construction of a conventional embedded system. The embedded system 10 receives multimedia content from a storage medium such as a computer 20 and a USB/HDD 30, and plays the received multimedia content through a codec 11. Accordingly, information on the multimedia content, which exists in the computer 20 or the storage medium, is required. However, since the embedded system obtains such information through the codec 11 only, the codec may inform the embedded system that the multimedia content cannot be played if an error occurs during the operation of the codec. The error occurring in the codec may cause a system crash of the entire embedded system.

The embedded system receives and plays a multimedia file from an external source, or plays a multimedia file that is stored in an external system. In this case, in order to play the multimedia file that is stored in a hard disk or a USB storage medium of an existing multimedia file playback system, a file system is searched for in the corresponding hard disk or USB device, and then multimedia content type files are selected among all the searched files, or a desired multimedia file is selected by searching each folder, that is, by window-type file browsing. In the case of browsing for a file in a general computer, a search interface is generally used to search for a folder in which a desired file exists. However, a mouse or a keyboard may be not supported in the playback-oriented embedded device, or even if a mouse or keyboard is supported in the embedded device, it may be difficult for the user to control the embedded device.

On the other hand, errors occurring in the multimedia content are mostly processed in the codec. Most problems occurring during the playback of a multimedia file occur in the hardware/software decoder. Even if a corresponding multimedia file is wrongly formatted or unsupported, a decoder is driven without filtering the file. The multimedia file is briefly divided into a video stream, an audio stream, and an image, and is classified into various formats. Since new formats are continuously developed and distributed, the decoder may not be able to properly process all the new formats.

Further, since compared to a general PC the embedded device has a low processing capability, a problem that occurs in a hardware/software decoder may directly cause a serious problem such as a system crash. Furthermore, if a corresponding embedded device implements the multimedia file play function or a device that should support streaming for a long time, the system may crash during the playback of unverified media files.

### SUMMARY OF THE INVENTION

Accordingly, an aspect of the present invention has been made to solve the above-mentioned problems occurring in the prior art, and an aspect of the present invention is to heighten the stability and processing speed when playing multimedia content through an embedded device.

Another aspect of the present invention is to easily list multimedia content in an embedded device.

Additional advantages, aspects, and features of the invention will be set forth in part in the description which follows and in part will become apparent to those having ordinary skill in the art upon examination of the following, or may be learned from practice of the invention.

There is provided an embedded device, according to an aspect of the present invention, which includes a content organizer which receives a header containing information on a multimedia file and extracts information required for playing the multimedia file from the header; a database of the extracted information for each multimedia file; and a decoding unit playing the multimedia file based on the information extracted by the content organizer.

In another aspect of the present invention, there is provided a method of selecting and playing a multimedia file playable in an embedded device, which includes receiving a header containing information on a multimedia file; extracting information required for playing the multimedia file from the header; storing the extracted information in a database in which information on multimedia files is stored; and deciding to playback the multimedia file based on the information stored in the database.

In still another aspect of the present invention, there is provided a method of selecting and playing a multimedia file playable in an embedded device, which includes receiving and storing a multimedia file; receiving a playback command for the stored multimedia file and extracting information required for playing the multimedia file before executing the playback command; and deciding whether the multimedia file can be played according to the extracted information, and playing the multimedia file according to the decision.

### BRIEF DESCRIPTION OF THE DRAWINGS

The above and other aspects, features and advantages of exemplary embodiments of the present invention will become apparent from the following detailed description taken in conjunction with the accompanying drawings, in which:

FIG. 1 is a view illustrating the construction of a conventional embedded system;

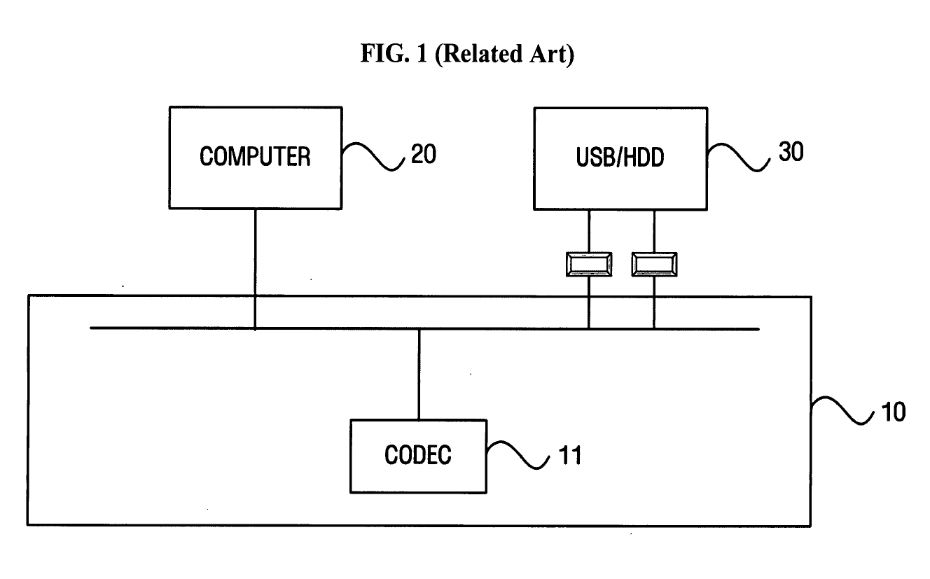

FIG. 2 is a view illustrating the construction of an embedded system or embedded device according to an exemplary embodiment of the present invention;

FIG. 3 is a view illustrating a process for arranging a content playback order according to an exemplary embodiment of the present invention;

FIG. 4 is a view illustrating information on multimedia content constructed as a database by a content organizer according to an exemplary embodiment of the present invention;

FIG. 5 is a flowchart illustrating a process of automatically detecting external multimedia content according to an exemplary embodiment of the present invention;

FIG. 6 is a flowchart illustrating a process of checking and playing a file that may be performed by a content organizer when an internal file is played according to an exemplary embodiment of the present invention; and

FIG. 7 is a view illustrating the construction of a content organizer, a database and a query processing unit according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of appended claims. Throughout the description of the present invention, the same drawing reference numerals are used for the same elements across various figures.

The exemplary embodiments of the present invention will be described with reference to the accompanying drawings illustrating block diagrams and flowcharts for explaining a method and apparatus for selecting and playing a multimedia file playable in an embedded device according to exemplary embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute through the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded into a computer or other programmable data processing apparatus to cause a series of operational steps to be performed in the computer or other programmable apparatus to produce a computer implemented process such that the instructions that execute in the computer or other programmable apparatus provide steps for implementing the functions specified in the flowchart block or blocks.

Also, each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

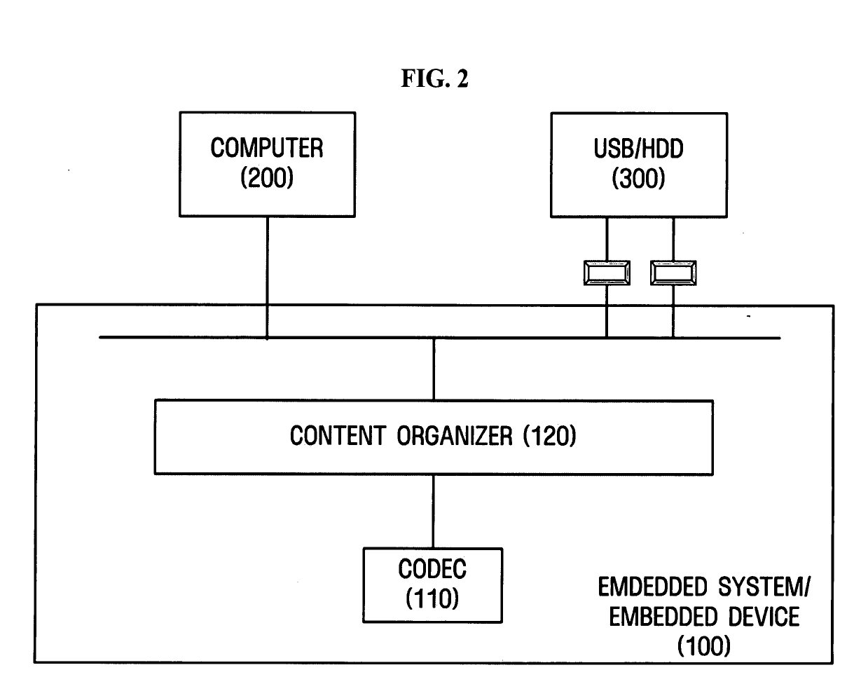

FIG. 2 is a view illustrating the construction of an embedded system or embedded device according to an exemplary embodiment of the present invention.

In the exemplary embodiment of the present invention, the term “unit”, that is, “module” or “table”, as used herein, means, but is not limited to, a software or hardware component, such as a Field Programmable Gate-Array (FPGA) or an Application-Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented so as to execute one or more CPUs in a device.

Multimedia content is received from a computer 200 and a storage medium 300, and information on the multimedia content may be checked by a content organizer 120. An embedded device 100 checks an attribute of the content through the content organizer before files stored in a storage device of a server PC through a network or files stored in a storage device such as a hard disk connected to a USB port are played. If it is difficult to play the content in the embedded device 100, or the content exceeds the processing capability of the embedded device 100, the embedded device 100 may crash. Accordingly, the content organizer 120 checks in advance whether the corresponding content or file can be supported by a hardware/software codec 110 included in the embedded device.

Also, the content organizer 120 automatically senses a connection with the hard disk or the USB storage medium that is connected to the embedded device having the multimedia playback function as its main function, automatically searches for a mounted partition, and detects a multimedia file. If it is determined by a basic checking process that the detected multimedia file is normal, the content organizer stores information on the corresponding file. This information may be stored using a specified database existing in the content organizer. A user does not need to search for unnecessary files or folders based on the stored information.

If the information on the multimedia content is obtained through the content organizer 120, the multimedia content file, which is stored in the computer 200 existing on the network or in the hard disk 300 connected to a USB port of the embedded device itself, can be automatically detected and listed without the necessity of searching and selecting a great number of files one by one. Additionally, problems such as rebooting the system due to problems occurring in the codec or the inability to play a file scheduled next to the present file can be solved by checking the problems before the multimedia content file is played directly through the codec.

The codec 110 decodes the multimedia content or multimedia file to play the decoded content or file. The codec performs the decoding according to diverse types of multimedia content such an MPEG, AVI, and MP3.

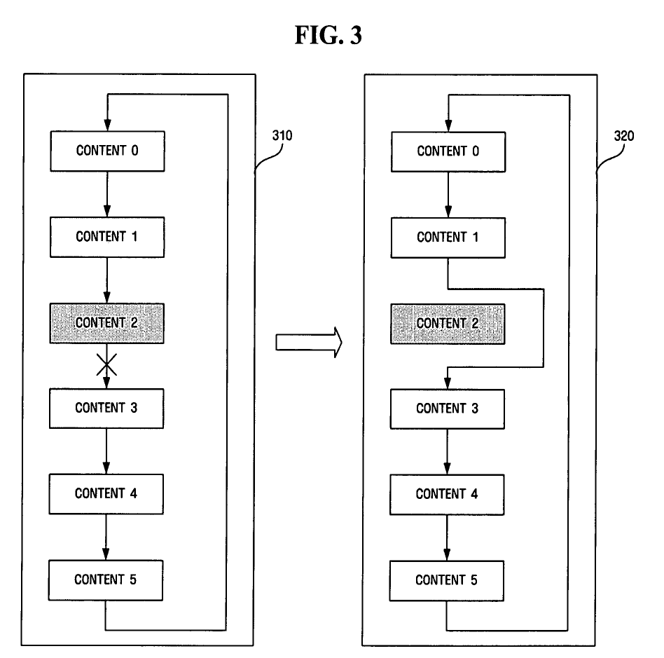

FIG. 3 is a view illustrating a process for arranging a content playback order according to an exemplary embodiment of the present invention.

Referring to FIG. 3, a reference numeral “310” indicates that the playback of six kinds of content is scheduled. If content 2 has a problem when the playback of content 1 is normally finished and the next content 2 is automatically played, the system may crash. Also, while content 2 is played, the corresponding program may crash, or content 3 cannot be played due to various exceptional problems. In order to overcome these problems, the content organizer checks basic information before the multimedia file is played. The reference numeral “320” indicates that the content organizer is applied to the embedded system as shown in FIG. 2. Referring to the reference numeral “320”, the scheduled “content 3” can be played without any problem by detecting in advance that content 2 has a problem. As a result, the waste of processing time from playing content 2 or the crashing of the system can be prevented.

Basic items which are checked by the content organizer in order to examine whether an error exists in the file are as follows: File format information can be checked. This information is included in the header of the file, and provides information required to play the content. Also, the format information can be checked by a file extender. For example, in the case of a video file, it can be judged whether the video file refers to an MPEG1, MPEG2 or MPEG3, while in the case of an audio file, it can be judged whether the audio file refers to an MP3, AAC, AC3 or WMA.

The content organizer confirms information such as a file name of the content, a file size, a date of creation, a creator, an album name, album information, a playback time, a stream rate, an encoding type, and others, in addition to a content type, and checks whether the decoder can support the content.

The content organizer can prevent a problem from occurring during the playback of the content which has an extender erroneously described therein by checking whether the file extender coincides with the information of the file header. For example, if the extender is “divx” whereas the file type is MPEG, an error occurs when the file is played through a “divx” codec. The content organizer checks the file type before the file is played, so that an MPEG decoder can play the file. Also, the content organizer can present information on such an error if the error exists as a result of checking the file.

The multimedia content can be played by down-grading the content according to the processing capability that can be provided by the embedded device. For example, when a resolution of the multimedia content is higher than that supported by the embedded device, the content can be played or stored by lowering the resolution. In addition, a method of playing the content by lowering the number of playable frames per second can be used.

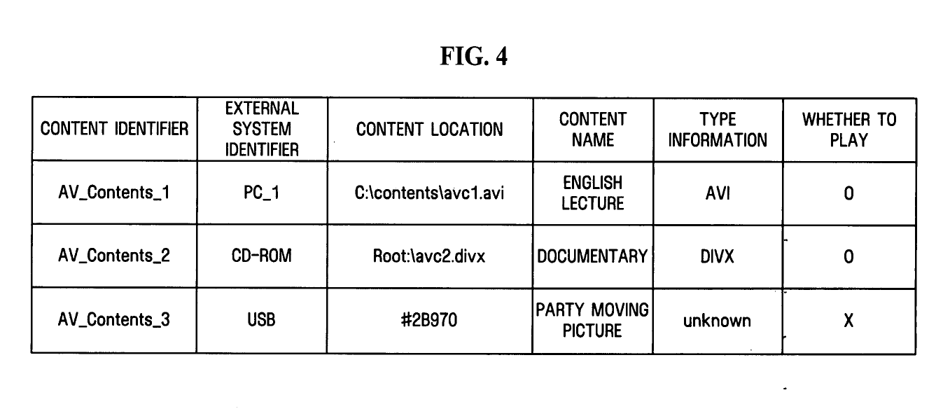

FIG. 4 is a view illustrating information on multimedia content constructed as a database by a content organizer according to an exemplary embodiment of the present invention.

Three kinds of multimedia content are shown in FIG. 4. Their content identifiers are AV_Content_{—}1, AV_Content_{—}2, and AV_Content_{—}3. An external system type, a content location, a content name and type information, and whether the playback is performed have been described for the respective content, and thus a content scheduling can be made using this information. The type of the AV_Content_{—}3 is indicated as “unknown”, and this means that the embedded device cannot play the corresponding content.

As shown in FIG. 4, a respective location of the multimedia content or multimedia file is stored in the database, and thus the corresponding multimedia content to be played can be easily found in the corresponding storage medium or an external system. Accordingly, the processes of searching and playing the multimedia content through a window type browsing can be reduced.

In addition, the user can select desired multimedia content among playback-related information stored in the database and play the selected multimedia content. That is, the resultant content can be obtained by providing a query to the database, for example, by searching for education-related content, moving picture-related content, music-related content, and others.

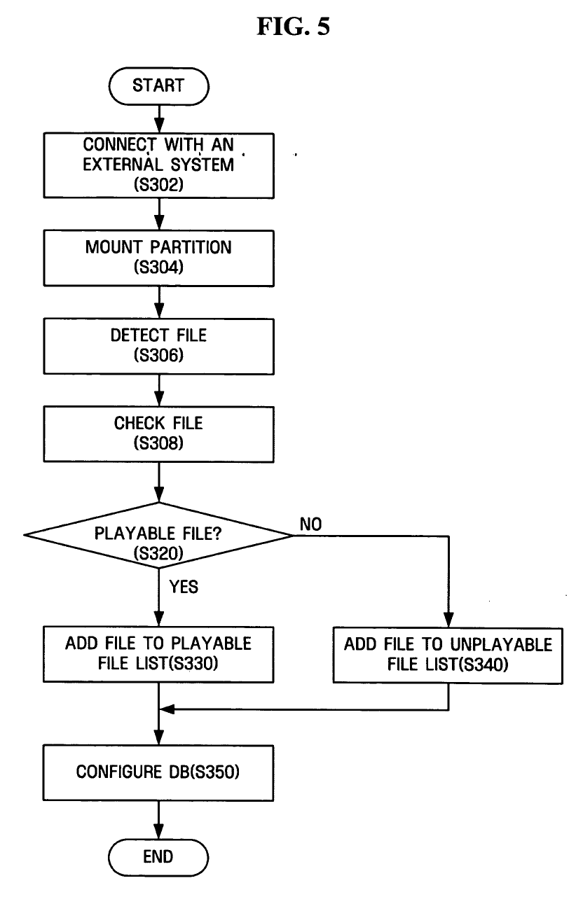

The database, may be created by a user's request or may be automatically created in association with an external system. For example, content information may be created by reading a partition of an external file system and then stored in the database. This process will be explained in more detail with reference to FIG. 5.

FIG. 5 is a flowchart illustrating a process of automatically detecting multimedia content stored on the outside according to an exemplary embodiment of the present invention. When an external system, for example, an external memory is connected through a computer or a USB S302, the external system can be recognized as the partition of a file system that is mounted S304. Files stored in the recognized external system are automatically searched for and extracted S306, and then the corresponding files are checked S308. In checking the files, a database structure of FIG. 4 and information stored in a file header part may be checked. If it is determined that the file is playable in the embedded device S320, the corresponding file is added to a list of playable files S330. By contrast, if the file is unplayable in the embedded device, the corresponding file is added to a list of unplayable files S340. After the steps S330 and S340, information on the file and whether the file can be played are stored in the database of FIG. 4 S350. Whether the multimedia content can be played in the connected external system may be read through a process as illustrated in FIG. 5.

Through the process of FIG. 5, respective drives are automatically recognized as the file systems are mounted according to a partition, and as the files in the mounted partition are automatically searched and checked, basic information and file path information of the playable multimedia files are automatically built in the database. Thereafter, an application can query the playable information in the corresponding storage medium to match a determined interface of the database with reference to the corresponding database only.

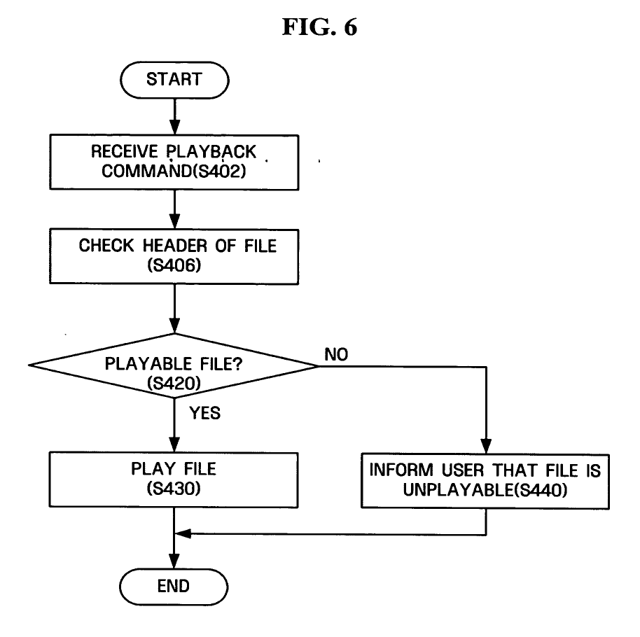

FIG. 6 is a flowchart illustrating a process of checking and playing a file that is performed by a content organizer when the file stored in an embedded system is played according to an exemplary embodiment of the present invention. If the user selects a specified file and instructs the playback of the file, the embedded device receives the playback instruction S402. The content organizer checks the header of the file S406. At this time, if information on the file exists in the database, the content organizer can check the information stored in the corresponding database. If it is checked that the file is playable S420, the content organizer makes a decoder play the file S430. By contrast, if the file is unplayable, the content organizer informs the user that the file is unplayable S440. When the content organizer informs the user that the corresponding content is unplayable in the embedded device, it may receive the result of selection whether the corresponding content is played through the decoder or the playback of the corresponding content is stopped.

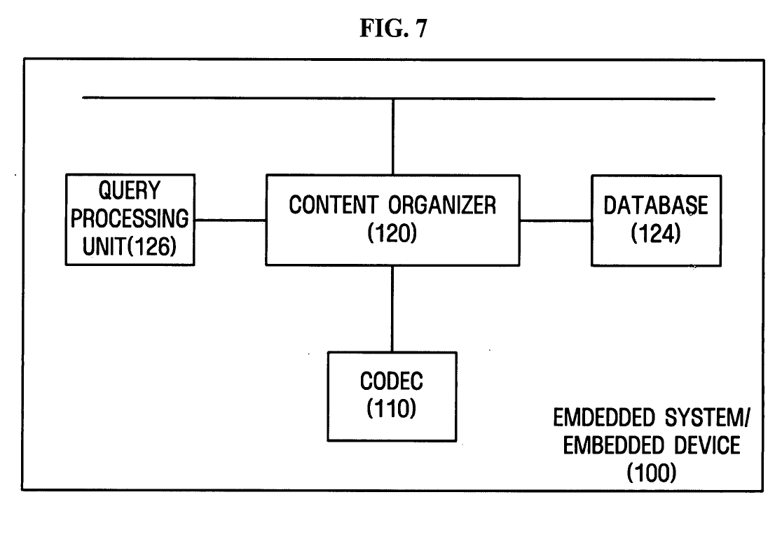

FIG. 7 is a view illustrating the construction of a content organizer, a database and a query processing unit according to an exemplary embodiment of the present invention.

A content organizer 120 stores information on multimedia content received from an external source in a database 124 of an embedded device such as a DVD, an MP3 player, a PDA, a HPC, a mobile phone, a PMD, and others. When an application of the embedded device intends to play a specified type of multimedia content or to search for catalogs of playable multimedia content, the content organizer 120 may transmit a query to a query processing unit 126. This query makes it possible to select the corresponding multimedia content through information stored in the database 124.

If a certain embedded device requires a continuous playback of diverse multimedia content for a week or a month, it is checked in advance whether the corresponding multimedia file can be played in order to prevent the stopping of a program or the system crash due to erroneous content. Accordingly, system crashes and program stoppage can be overcome.

Since folders or files can be searched for through the content organizer, and the files reside in a database, the processing speed and the stability of the embedded device are increased.

As described above, according to the exemplary embodiments of the present invention, the stability and the processing speed when playing multimedia content in an embedded device are increased.

Also, according to the exemplary embodiments of the present invention, multimedia content can be easily listed and played in an embedded device.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An embedded device comprising:
a content organizer which receives a header that includes information on a multimedia file and extracts information required for playing the multimedia file from the header;
a database which stores the extracted information for the multimedia file; and
a decoding unit which plays the multimedia file based on the information extracted by the content organizer.

2. The device of claim 1, wherein the content organizer determines whether a playback of the multimedia file is possible on the basis of the extracted information or information stored in the database.

3. The device of claim 2, wherein the extracted information includes at least one of file format information, a file size, a file name, a date of creation of the file, a creator of the file, an album name, a playback time, a streaming rate, and an encoding type.

4. The device of claim, 3, wherein the format information is checked by determining whether a file extender coincides with header information.

5. The device of claim 1, wherein the multimedia file is played by lowering the resolution of the multimedia content based on the processing capability of the embedded device.

6. The device of claim 1, wherein a user selects multimedia content based on at least one predetermined category of multimedia content.

7. The device of claim 6, wherein the at least one predetermined category includes at least one of education-related content, moving picture-related content, and music-related content.

8. The device of claim 1, further comprising a query processing unit which extracts identification information of the multimedia file which satisfies a specified condition from the information that is required for the playback of the multimedia file and stored in the database.

9. The device of claim 1, wherein the decoding unit decodes the multimedia file and plays the decoded multimedia file.

10. A method of selecting and playing a multimedia file playable in an embedded device, comprising:
receiving a header that includes information on a multimedia file;
extracting information required for playing the multimedia file from the header;
storing the extracted information in a database in which information on multimedia files is stored; and
deciding a playback of the multimedia file based on the information stored in the database.

11. The method of claim 10, wherein the header of the file includes information on a content type of the file, a content explanation, a file name, a file size, a streaming rate, and an encoding type.

12. The method of claim 10, further comprising continuously receiving a part of the multimedia file in order to play the multimedia file in the case where the multimedia file is stored in an external system.

13. The method of claim 10, wherein the embedded device decodes the multimedia file and plays the decoded multimedia file.

14. The method of claim 10, further comprising:
receiving a command for playing the multimedia file;
extracting the information required for playing the multimedia file from the database; and
not performing the playback of the multimedia file if the extracted information indicates that playback of the multimedia file is impossible.

15. The method of claim 14, wherein it is determined that the playback of the multimedia file is impossible when the extracted information indicates that a format is incompatible with the embedded device.

16. The method of claim 10, further comprising:
extracting identification information of the multimedia file which satisfies a specified condition from the information that is required for the playback of the multimedia file, and which is stored in the database; and
playing the multimedia file of the extracted identification information.

17. A method of selecting and playing a multimedia file playable in an embedded device, comprising:
receiving and storing a multimedia file;
receiving a playback command for the stored multimedia file and extracting information required for playing the multimedia file before executing the playback command; and
deciding whether the multimedia file can be played according to the extracted information and playing the multimedia file according to the decision.

18. The method of claim 17, wherein the information required for playing the multimedia file includes information on at least one of content type of the file, a content explanation, a file name, a file size, a streaming rate, and an encoding type.

19. The method of claim 17, further comprising continuously receiving a part of the multimedia file so as to play the multimedia file in the case where the multimedia file is stored in an external system.

20. The method of claim 17, wherein the embedded device decodes the multimedia file and plays the decoded multimedia file.

21. The method of claim 17, further comprising storing the extracted information in the database, in which playback information of the multimedia file is stored, after the extracting step.

22. The method of claim 21, further comprising:
extracting identification information of the multimedia file which satisfies a specified condition from the information that is required for the playback of the multimedia file, and which is stored in the database; and
playing the multimedia file of the extracted identification information.
